(19) United States
(12) Patent Application Publication
(10) Pub. No.: US 2025/0172202 A1
(43) Pub. Date: May 29, 2025

(54) DRIVEN AXLE FOR A VEHICLE

(71) Applicant: ZF Friedrichshafen AG, Friedrichshafen (DE)

(72) Inventor: Enrico Herfurth, Neukirchen vorm Wald (DE)

(73) Assignee: ZF Friedrichshafen AG, Friedrichshafen (DE)

(21) Appl. No.: 18/958,473

(22) Filed: Nov. 25, 2024

(30) Foreign Application Priority Data
Nov. 29, 2023 (DE) 10 2023 211 924.2

(51) Int. Cl. F16H 48/08; B60B 35/16; B60K 17/16; F16H 48/22; F16H 48/32; F16H 48/40; F16H 57/02; F16H 57/021; F16H 57/037

(52) U.S. Cl. CPC F16H 48/08; B60K 17/165; F16H 48/22; F16H 57/021; F16H 57/037; B60B 35/16; B60B 2900/113; B60B 2900/115; B60B 2900/131; B60B 2900/325; F16H 2048/082; F16H 48/32; F16H 2048/405; F16H 2057/02026; F16H 2057/02052

(57) ABSTRACT

A drive axle for a vehicle has a differential gearing system 3 arranged in a transmission housing 1, which differential is connected by plug-in shafts 5 to wheel hubs 7, where the plug-in shafts 5 extend through axle housings 2. The plug-in shafts 5 are arranged with their ends facing toward the differential gearing 3 fixed on the axle bevel gears 4 of the differential gearing 3. A transmitter wheel 9 is arranged on one or both plug-in shafts 5, whose rotary movement can be detected by a rotation speed sensor 8 arranged on the transmission housing 1 or the axle housing 2. The plug-in shafts 5 are guided radially, directly or indirectly, on the transmission housing 1 or in an area of the axle housing 2 adjacent to the transmission housing 1.

### RELATED APPLICATIONS

This application claims the benefit of and right of priority under 35 U.S.C. § 119 to German Patent Application no. 10 2023 211 924.2, filed on 29 Nov. 2023, the contents of which are incorporated herein by reference in its entirety.

### FIELD OF THE DISCLOSURE

The invention relates to a drive axle for a vehicle with a differential gearing arranged in a transmission housing, which differential is connected to wheel hubs by way of plug-in shafts, wherein the plug-in shafts extend through axle housings, wherein the plug-in shafts are arranged with their ends facing toward the differential gearing fixed on the bevel gears of the axle, and wherein there is arranged on one or both plug-in shafts a transmitter wheel whose rotation movement can be detected by a rotation speed sensor arranged on the transmission housing or the axle housing.

### BACKGROUND

In such a drive axle the plug-in shaft is mounted in a floating manner, wherein on the transmission side it is aligned with the working teeth of the axle bevel gears. On the wheel head side a planetary gearset is driven by the plug-in shaft and the alignment takes place in the working teeth of the planetary gearset.

During the operation of the vehicle, due among other things to load changes, oscillations and deflections of the plug-in shafts resulting in signal suspension of the rotation speed sensors can occur, and this results in incorrect further processing of the rotation speed signals.

### SUMMARY

The purpose of the present invention is therefore to provide a drive axle for a vehicle of the type mentioned to begin with, which avoids that drawback so that at least largely correct rotation speed signals are produced by the rotation speed sensors, and which has a simple structure and essentially does not require any enlargement of the fitting space needed.

According to the invention this objective is achieved if the plug-in shafts pass radially directly or indirectly to the transmission housing or to an area of the axle housing adjacent to the transmission housing.

This guiding results in a pre-centering of the plug-in shafts and reduces their oscillations and deflections, so that at least to a large extent correct rotation speed signals are produced by the rotation speed sensor. An advantageous possibility for the guiding is that the axle bevel gears are guided radially and rotatably by means of bearings on the differential cage.

In that case the plug-in shafts are centered in a simple manner by means of the axle bevel gears.

A further advantageous possibility for the guiding is that one or both plug-in shaft(s) is/are guided radially and rotatably by bearings on the axle housings or on the transmission housing.

Another advantageous possibility for the guiding is that one or both plug-in shaft(s) is/are guided radially and rotatably by bearings on the differential cage of the differential gearing.

In a simply designed manner, the above-mentioned bearings can be slide bearings or roller bearings.

A further advantageous possibility for the guiding is that the differential gearing is a locking differential transmission with a disk packet arranged coaxially with the plug-in shaft, which packet consists of alternating axially displaceable inner disks and outer disks, wherein the disk packet can be actuated axially, directly or indirectly, by the force of a pressure piece in the form of a sliding sleeve which can be displaced axially on the plug-in shaft and actuated by force, whereby the plug-in shaft is guided radially and rotatably on the sliding sleeve.

It is also possible for the differential gearing to be a locking differential transmission with a disk packet arranged coaxially with the plug-in shaft, which packet consists of alternating axially displaceable inner disks and outer disks, wherein the disk packet can be actuated axially, directly or indirectly, by the force of a hydraulically actuated annular pressure piston which can be displaced axially on the plug-in shaft, whereby the plug-in shaft is guided radially and rotatably on the pressure piston.

It is also possible for the differential gearing to be a locking differential transmission with a disk packet arranged coaxially with the plug-in shaft, which consists of alternating axially displaceable inner disks and outer disks, wherein the inner disks with their radially all-round outer disks are guided rotatably and radially on the differential cage and/or on a locking lid that encloses the disk packet.

A further possibility is for the differential gearing to be a locking differential transmission with a disk packet arranged coaxially with the plug-in shaft, which packet consists of alternating axially displaceable inner disks and outer disks, wherein the outer disks with their radially all-round inner circumference are guided rotatably and radially on a cylindrical attachment of the axle bevel gear.

### BRIEF DESCRIPTION OF THE DRAWINGS

Example embodiments of the invention are shown in the drawing and described in greater detail in what follows. The drawing shows:

FIG. 1: A longitudinal section of a differential gearing system arranged in a transmission housing and a plug-in shaft of a drive axle of a vehicle, the shaft passing through an axle housing to a wheel head, according to the prior art

FIG. 2: A longitudinal section of a first example embodiment of a plug-in shaft supplemented by guiding means, for a drive axle of a vehicle, according to FIG. 1

FIG. 3: A longitudinal section of a second example embodiment of a plug-in shaft supplemented by guiding means, for a drive axle of a vehicle, according to FIG. 1

FIG. 4: A longitudinal section of a third example embodiment of a plug-in shaft supplemented by guiding means, for a drive axle of a vehicle, according to FIG. 1

FIG. 5: A longitudinal section of a fourth example embodiment of a plug-in shaft supplemented by guiding means, for a drive axle of a vehicle, according to FIG. 1

FIG. 6: An enlarged section of the example embodiment shown in FIG. 5.

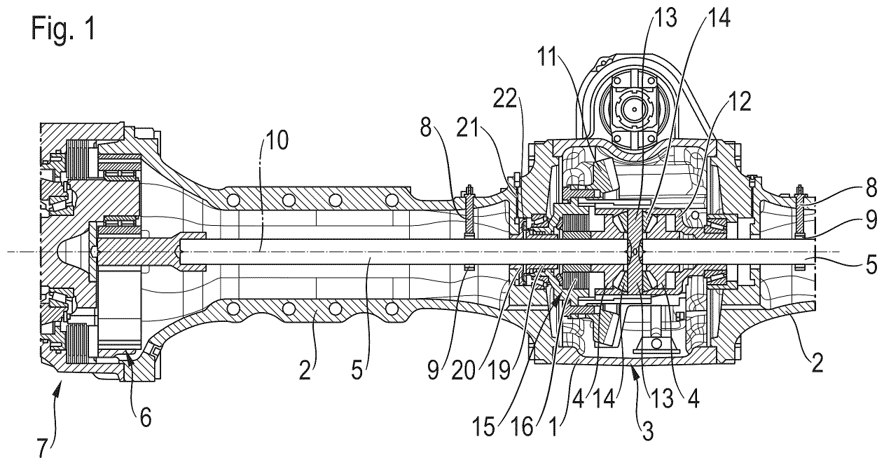

### DETAILED DESCRIPTION

The drive axles shown comprise a transmission housing 1 onto which diametrically opposite tubular axle housings 2 are flanged.

In the transmission housing there is arranged a differential gearing system 3 on the axle bevel gears 4 of which the radially inward-projecting ends of plug-in shafts 5 are arranged in a rotationally fixed manner, so that alignment takes place in the working teeth of the differential gearing.

The plug-in shafts 5 that can rotate about a rotation axis 10 pass through the axle housing 2 to planetary drives 6 arranged in wheel heads 7 and with their outward-projecting ends are aligned in the working teeth of the planetary drive.

Thus, the plug-in shafts are mounted in a floating manner.

In the axle housings 2 there are arranged radially inward-projecting rotation speed sensors 8, which are directed toward positionally fixed transmitter wheels 9 radially surrounding the plug-in shafts 5 and which detect the rotation speed of the plug-in shafts 5. The signals from the rotation speed sensors are sent to evaluation units by way of lines (not shown), for further processing.

The differential gearing 3 comprises a large coaxial bevel gear 11 mounted to rotate relative to the rotation axis 10, which can be driven in rotation by a drive unit (not shown).

On the large bevel gear 11 is arranged a differential cage 12 that consists of two pot-like parts, which at its axial ends is mounted to rotate, respectively on one of the plug-in shafts 5, about the rotation axis 10.

A bearing bolt 13 extends transversely to the rotation axis 10 and is fixed with its free ends on the radially surrounding walls of the differential cage 12. On the bearing bolt 13 are rotatably mounted two pinion gears 14 opposite one another, each respectively engaging in the two axle bevel gears 14.

Inside the left-hand part of the differential cage 12 is arranged a lock 15 that can be engaged hydraulically, which comprises a disk packet 16 arranged coaxially with the plug-in shaft 5, which packet consists of alternating, axially displaceable inner disks 17 and outer disks 18, wherein the disk packet 16 can be acted upon with force to compress it by a pressure piece in the form of a siding sleeve 19 that can be displaced axially on the plug-in shaft 5.

In turn the sliding sleeve 19 can be acted upon by an annular pressure piston 20 that surrounds the plug-in shaft 5, which piston is arranged and can be displaced in an annular cylindrical recess 22 of the left-hand axle housing 2 and can be actuated by pressure via a hydraulic connection 21.

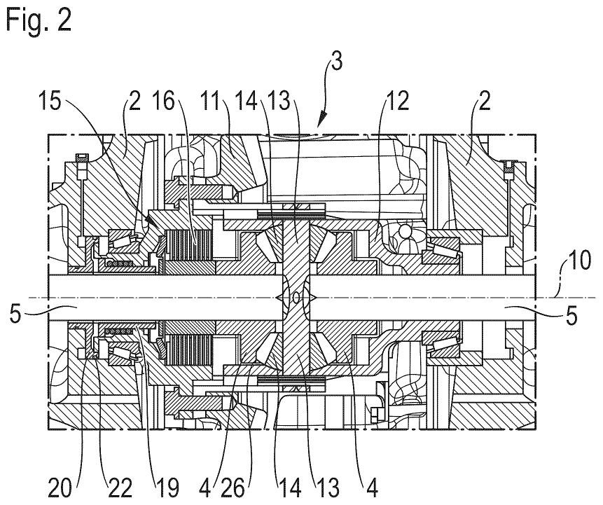

In the example embodiment of FIG. 2, for the axial guiding of the plug-in shaft the radially surrounding shell surface 26 of the axle bevel gear has approximately the same outer diameter as the inner diameter of the enclosed differential cage 12.

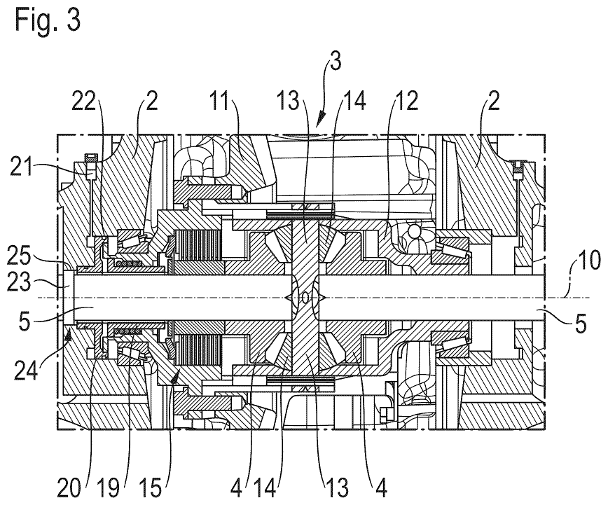

In the example embodiment of FIG. 3, axially outside the differential gearing 3 and the lock 15 there is arranged on the plug-in shaft 5 a ring 23 of a slide bearing 24, which is fitted rotatably with its outer circumference against a cylindrical surface 26 of the axle housing 2 and is thus radially guided.

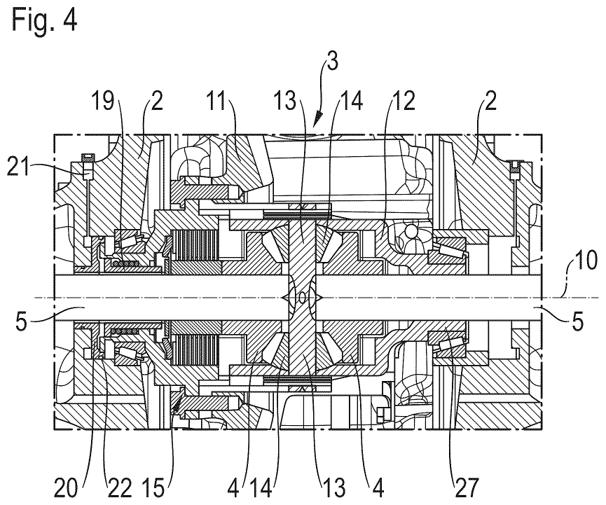

In the example embodiment of FIG. 4, on the left-hand side two possibilities for radial guiding of the plug-in shaft 5 are shown.

In one of them the plug-in shaft 5 has approximately the same outer diameter as the inner diameter of the pressure piston 20 of the lock 15.

Alternatively, the plug-in shaft 5 can have approximately the same outer diameter as the inner diameter of the sliding sleeve 19.

On the right-hand side of FIG. 4, as a further possibility an outer diameter of the plug-in shaft 5 is enclosed by the approximately equal diameter of an area 27 of the differential cage 12.

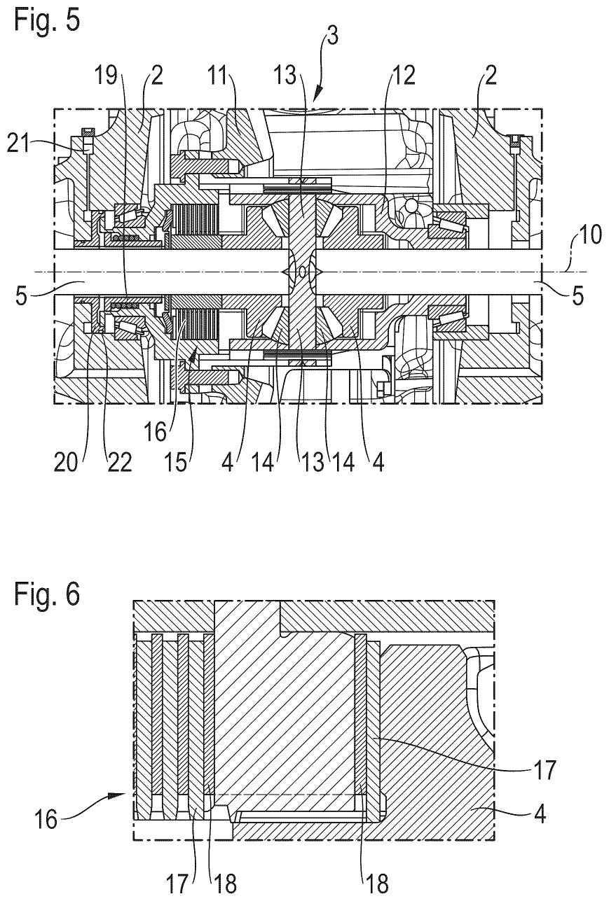

In the example embodiment shown in FIGS. 5 and 6, for the radial guiding of the plug-in shaft 5 an inner disk 17 of the disk packet 16 has an outer diameter which is approximately equal to the inner diameter of the enclosed cylindrical part of the differential cage 12. It is understood that this can also be the case with further inner disks 17.

### INDEXES

1 Transmission housing
2 Axle housing
3 Differential gearing
4 Axle bevel gears
5 Plug-in shafts
6 Planetary gearing
7 Wheel hub
8 Rotation speed sensors
9 Transmitter wheel
10 Rotation axis
11 Large bevel gear
12 Differential cage
13 Bearing bolt
14 Pinion gears
15 Lock
16 Disk packet
17 Inner disks
18 Outer disks
19 Sliding sleeve
20 Pressure piston
21 Hydraulic connection
22 Annular cylinder recess
23 Ring
24 Slide bearing
25 Bearing surface
26 Shell surface
27 Area

1. A driven axle for a vehicle, comprising:
a differential gearing system (3) arranged in a transmission housing (1),;
plug-in shafts;
wheel hubs;
axle housings;
a rotation speed sensor on the transmission housing or on one of the axle housings;
a transmitter wheel arranged rotationally fixed on at least one of the plug-in shafts;
wherein the differential gearing system is connected to wheel hubs (7) by means of the plug-in shafts (5);
wherein the plug-in shafts (5) extend through the axle housings (2) with ends of the plug-in shafts facing toward the differential gearing (3);
wherein the plug-in shafts (5) are arranged fixed to axle bevel gears (4) of the differential gearing (3), and
wherein a transmitter wheel (9) is arranged rotationally fixed on at least one of the plug-in shafts (5);
wherein rotation movement of the transmitter wheel (9) being detectable by a rotation speed sensor (8); and
wherein the plug-in shafts (5) are directly or indirectly guided radially by the transmission housing (1) or in an area of the axle housing (2) adjacent to the transmission housing (1)

2. The driven axle according to claim 1, wherein the axle bevel gears are rotatably and radially guided by bearings on the differential cage (12).

3. The driven axle according to claim 1, wherein at least one of the plug-in shafts (5) is rotatably and radially guided by bearings on the axle housings (2) or the transmission housing (1).

4. The driven axle according to claim 1, wherein at least one of the plug-in shafts (5) is rotatably and radially guided by bearings on the differential cage (12) of the differential gearing (3).

5. The driven axle according to claim 2, wherein the bearings are slide bearings (24) or roller bearings.

6. The driven axle according to claim 1, wherein the differential gearing (3) is a locking differential transmission with a disk packet (16) arranged coaxially with the plug-in shafts (5), which packet consists of alternating, axially displaceable inner disks (17) and outer disks (18), wherein the disk packet (16) can be actuated by force axially, directly or indirectly, by a pressure piece that can be displaced axially on the plug-in shaft (5) under the action of force, the pressure piece being in the form of a sliding sleeve (19), and wherein the plug-in shaft (5) is guided rotatably and radially on the sliding sleeve (19).

7. The driven axle according to claim 1, wherein the differential gearing (3) is a locking differential transmission with a disk packet (16) arranged coaxially with the plug-in shafts (5), which packet consists of alternating, axially displaceable inner disks (17) and outer disks (18), wherein the disk packet (16) can be hydraulically actuated axially, directly or indirectly, by an annular pressure piston (20) that can be displaced axially on the plug-in shaft (5) under the action of force, wherein the plug-in shaft (5) is guided rotatably and radially on the pressure piston (20).

8. The driven axle according to claim 1, wherein the differential gearing (3) is a locked differential transmission with a disk packet (16) arranged coaxially with the plug-in shafts (5), which packet consists of alternating, axially displaceable inner disks (17) and outer disks (18), wherein the inner disks (17) are guided rotatably and radially with their radially all-round outer circumference on the differential cage (12) and/or on a locking lid that encloses the disk packet (16).

9. The driven axle according to claim 1, wherein the differential gearing (3) is a locked differential transmission with a disk packet (16) arranged coaxially with the plug-in shafts (5), which packet consists of alternating, axially displaceable inner disks (17) and outer disks (18), wherein the outer disks (18) are guided rotatably and radially with their radially all-round inner circumference on a cylindrical attachment of the axle bevel gear (4).
